(19) United States
(12) Patent Application Publication
(10) Pub. No.: US 2011/0275757 A1
(43) Pub. Date: Nov. 10, 2011

(54) POLYURETHANE-BASED SURFACTANTS

(75) Inventors: Jan Schönberger, Haan (DE); Sebastian Dörr, Dusseldorf (DE)

(73) Assignee: Bayer MaterialScience AG, Leverkusen (DE)

(21) Appl. No.: 13/144,721

(22) PCT Filed: Jan. 13, 2010
(86) PCT No.: PCT/EP2010/000128

§ 371 Date: Jul. 15, 2011

(30) Foreign Application Priority Data
Jan. 24, 2009 (EP) 09000994.5

(51) Int. Cl. C08L 75/04; C08G 18/00

(52) U.S. Cl. 524/590; 525/460

(57) ABSTRACT

The present invention relates to novel, high molecular weight surfactants based on polyurethanes for use in coatings, adhesives or sealants, for example.

The present invention relates to novel, high molecular weight surfactants based on polyurethanes for use in coatings, adhesives or sealants, for example.

It has recently become a necessity in some fields of application as well as a topic of increasing interest to replace low molecular weight added substances such as surfactants, wetting and dispersing agents, stabilizers or else thickeners for example by high molecular weight added substances in polymeric formulations for a wide variety of applications.

An example to be mentioned in this connection is a (supracutaneous) irritant effect or even toxic effect of commercially available low molecular weight substances on organisms, in particular plants, animals and humans. The results are usually cytotoxic coatings, adhesive layers and seals. In many cases, such an undesirable effect is attributable inter alia to the low molecular weight character of the added substances, since molecules having molar masses below 500 g/mol are generally appreciably more active physiologically than compounds having higher molecular weights.

However, the low molecular weight of surfactants is frequently also associated with positive properties, which are not always achievable with compounds having molar masses above 500 g/mol.

EP 0731148 describes hydrophilic-modified branched polyisocyanate adducts based on polyisocyanates having an average NCO functionality of at least 2.5, which are reacted with hydrophilic polyethers. These components have the disadvantage that the relatively high degree of branching prevents optimal actualization of the hydrophilic potential of the polyether chain, since steric reasons make it impossible for more than 2 polyether chains to be fully in the aqueous phase at the same time when the hydrophobic moiety of the adduct is at the same time localized at a hydrophobic phase. As a result, part of the hydrophilic moiety of the dispersing auxiliaries described in EP 0731148 will always be close to the hydrophobic phase.

The present invention therefore has for its object to provide suitable high molecular weight surfactants as (foam) additives which can be frothed in combination with polymers or polymer mixtures, preferably with polyurethanes, especially with aqueous polyurethane dispersions, and, after drying, provide finely pored foams which are homogeneous even when very thick and which are not cytotoxic and are very substantially free of (thermally) detachable components such as amines.

It has now been found that this object is achieved when novel surfactants, based on polyurethanes, are used as an additive.

The present invention accordingly provides polyurethanes having a free isocyanate group content of not more than 1.0% by weight and a 10% to 95% by weight content of ethylene oxide units (molecular weight=44 g/mol) incorporated via monofunctional alcohols B) and arranged within polyether chains, which have been prepared by reaction of
A) polyisocyanate prepolymers having an (average) NCO functionality in the range from 1.7 to 2.5; preferably in the range from 1.8 to 2.2; more preferably 2 with
B) 10 to 100 equivalent %, based on the isocyanate groups of A), of a monohydric alcohol component comprising at least one monohydric polyether alcohol having a number average molecular weight in the range from 150 to 5000 g/mol and an oxyethylene units content of 30 to 100% by weight, based on the total content of oxyalkylene units in the monohydric polyether alcohol,
C) 0 to 20 equivalent %, based on the isocyanate groups of A), of a monohydric alcohol component comprising monohydric alcohols having a number average molecular weight in the range from 32 to 5000 g/mol which are other than the compounds of component B),
D) 0 to 80 equivalent %, based on the isocyanate groups of A), of constructional components having a number average molecular weight in the range from 32 to 10 000 g/mol which are at least difunctional for the purposes of the NCO addition reaction
with urethane formation and with or without urea formation, wherein any excess NCO groups have been reacted away, by simultaneous or subsequent secondary reactions, down to a residual content of not more than 1.0% by weight.

The content of ethylene oxide units (molecular weight=44 g/mol) in the polyurethanes of the present invention is preferably in the range from 20% to 75% by weight, more preferably in the range from 35% to 60% by weight and most preferably in the range from 45% to 55% by weight. The content of free isocyanate groups in the polyurethanes of the present invention is below 1% by weight; and, in general, free isocyanate groups are no longer detectable.

Suitable polyisocyanate prepolymers for component A) are the well-known aliphatic, aromatic or cycloaliphatic isocyanate-functional prepolymers having the aforementioned NCO functionalities.

The isocyanate-functional prepolymers useable in A) are obtainable by reaction of polyisocyanates with hydroxyl-functional polyols in the presence or absence of catalysts and also in the presence or absence of auxiliary and adjunct materials.

Examples of such suitable isocyanate-functional building blocks A) are prepolymers based on polyols and low molecular weight isocyanate building blocks. Low molecular weight isocyanate building blocks are compounds such as 1,4-butylene diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 4-isocyanatomethyl-1,8-octane diisocyanate (nonane triisocyanate), 1,4-phenylene diisocyanate, 2,4- and/or 2,6-tolylene diisocyanate, 1,5-naphthylene diisocyanate, 2,2′- and/or 2,4′- and/or 4,4′-diphenylmethane diisocyanate, 1,3- and/or 1,4-bis(2-isocyanatoprop-2-yl)benzene (TMXDI), 1,3-bis(isocyanatomethyl)benzene (XDI) and also alkyl 2,6-diisocyanatohexanoates (lysine diisocyanates) having C1-C8-alkyl groups.

The isocyanate-functional components A) may contain for example uretdione, isocyanurate, urethane, urea, allophanate, biuret, iminooxadiazinedione or oxadiazinetrione structures and also mixtures thereof.

The polymeric polyols for preparing A) are the well-known polyurethane coating technology polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols. These can be used for preparing the prepolymer A) individually or in any desired mixtures with each or one another.

Suitable polyester polyols are the well-known polycondensates formed from di- and also optionally tri- and tetraols and di- and also optionally tri- and tetracarboxylic acids or hydroxy carboxylic acids or lactones. Instead of the free polycarboxylic acids it is also possible to use the corresponding polycarboxylic anhydrides or corresponding polycarboxylic esters of lower alcohols for preparing the polyesters.

Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentyl glycol or neopentyl glycol hydroxypivalate, of which 1,6-hexanediol and isomers, 1,4-butanediol, neopentyl glycol and neopentyl glycol hydroxypivalate are preferred. Besides these it is also possible to use polyols such as trimethylolpropane, glycerol, erythritol, pentaerythritol, trimethylolbenzene or trishydroxyethyl isocyanurate.

Useful dicarboxylic acids include phthalic acid, isophthalic acid, terephthalic acid, tetra-hydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethyl glutaric acid and/or 2,2-dimethylsuccinic acid. The corresponding anhydrides can also be used as a source of an acid.

When the average functionality of the polyol to be esterified is greater than 2, monocarboxylic acids, such as benzoic acid and hexanecarboxylic acid can be used as well in addition.

Preferred acids are aliphatic or aromatic acids of the aforementioned kind. Adipic acid, isophthalic acid and phthalic acid are particularly preferred.

Hydroxy carboxylic acids useful as reaction participants in the preparation of a polyester polyol having terminal hydroxyl groups include for example hydroxycaproic acid, hydroxybutyric acid, hydroxydecanoic acid, hydroxystearic acid and the like. Suitable lactones include caprolactone, butyrolactone and homologues. Caprolactone is preferred.

Low molecular weight polyols can also be used for preparing A). Examples of such polyols are ethylene glycol, 1,2-propanediol, 1,3-propanediol, 1,3-butanediol, 1,4-butanediol, 1,6-hexanediol, 1,8-octanediol, neopentyl glycol, 1,4-bishydroxymethylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned kind.

The use of polyether polyols for preparing A) is preferred.

The polyether polyols for preparing component A) generally have number average molecular weights Mn in the range from 300 to 8000 g/mol, preferably in the range from 400 to 6000 g/mol and more preferably in the range from 600 to 3000 g/mol.

It is further particularly preferable for them to have an unsaturated end group content of not more than 0.02 milliequivalents per gram of polyol (meq/g), preferably not more than 0.015 meq/g and more preferably not more than 0.01 meq/g (method of determination: ASTM D2849-69).

The polyols of the present surfactants based on polyurethanes (I) preferably have an OH functionality in the range from 1.5 to 4, more preferably in the range from 1.8 to 2.5 and most preferably in the range from 1.9 to 2.1.

It is particularly preferable for them to have a particularly narrow molecular weight distribution, i.e. a polydispersity (PD=Mw/Mn) in the range from 1.0 to 1.5, and/or an OH functionality of greater than 1.9. The polyether polyols mentioned preferably have a polydispersity in the range from 1.0 to 1.5 and an OH functionality of greater than 1.9 and more preferably of not less than 1.95.

Such polyether polyols are obtainable in a conventional manner by alkoxylation of suitable starter molecules, particularly under double metal cyanide (DMC) catalysis. This is described for example in U.S. Pat. No. 5,158,922 (Example 30 for instance) and EP-A 0 654 302 (page 5 line 26 to page 6 line 32).

Suitable starter molecules for preparing the polyether polyols are, for example, simple, low molecular weight polyols, water, organic polyamines having at least two N—H bonds or any desired mixtures thereof. Suitably alkylene oxides for the alkoxylation are, in particular, ethylene oxide and/or propylene oxide, which can be used in any desired order or else in admixture in the alkoxylation reaction.

Preferred starter molecules for preparing the polyether polyols by alkoxylation, particularly by following the DMC method, are, in particular, simple polyols such as ethylene glycol, diethylene glycol, triethylene glycol, butyl diglycol, 1,3-butylene glycol, 1,3-propylene glycol, 1,2-propanediol, 1,3-propanediol, 1,4-butanediol, 1,6-hexanediol, cyclohexanediol, 1,4-cyclohexane-dimethanol, neopentyl glycol, 2-ethyl-1,3-hexanediol, glycerol, trimethylolethane, trimethylolpropane, pentaerythritol, sorbitol, triethanolamine, hydroquinone dihydroxyethyl ether, bisphenol A (2,2-bis(4-hydroxyphenyl)propane), hydrogenated bisphenol A (2,2-bis(4-hydroxy-cyclohexyl)propane) and also low molecular weight hydroxyl-containing esters of such polyols with dicarboxylic acids of the kind exemplified hereinbelow or low molecular weight ethoxylation or propoxylation products of such simple polyols, or any desired mixtures of such modified or unmodified alcohols.

Useful polyether polyols include for example the well-known polyurethane chemistry polytetramethylene glycol polyethers obtainable by polymerization of tetrahydrofuran by means of cationic ring opening, and also polypropylene glycol and polycarbonate polyols, or mixtures thereof, with particular preference being given to polypropylene glycol.

Useful polyether polyols likewise include the well-known addition products of styrene oxide, ethylene oxide, propylene oxide, butylene oxide and/or epichlorohydrin onto di- or polyfunctional starter molecules.

Also suitable are ester diols of the specified molecular weight range such as α-hydroxybutyl-ε-hydroxycaproic acid ester, ω-hydroxyhexyl-γ-hydroxybutyric acid ester, β-hydroxyethyl adipate or bis(β-hydroxyethyl)terephthalate.

Monofunctional isocyanate-reactive hydroxyl-containing compounds may also be used. Examples of such monofunctional compounds are ethanol, n-butanol, ethylene glycol monobutyl ether, diethylene glycol monomethyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 2-ethylhexanol, 1-octanol, 1-dodecanol, 1-hexadecanol.

It is further possible to use NH₂— and/or NH-functional components for preparing the isocyanate prepolymers.

Suitable components for chain extension are organic di- or polyamines such as, for example, ethylenediamine, 1,2- and 1,3-diaminopropane, 1,4-diaminobutane, 1,6-diaminohexane, isophoronediamine, isomer mixtures of 2,2,4- and 2,4,4-trimethylhexamethylenediamine, 2-methylpentamethylenediamine, diethylenetriamine, diaminodicyclohexylmethane and/or dimethylethylenediamine.

It is further possible to use compounds which as well as a primary amino group also have secondary amino groups or which as well as an amino group (primary or secondary) also have OH groups. Examples thereof are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine, which are used for chain extension or termination. Chain termination typically utilizes amines having one isocyanate-reactive group such as methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amide-amines formed from diprimary amines and monocarboxylic acids, monoketime of diprimary amines, primary/tertiary amines, such as N,N-dimethylaminopropylamine.

The compounds of component A) are preferably prepolymers of the aforementioned kind having exclusively aliphatically or cycloaliphatically attached isocyanate groups or mixtures thereof and an average NCO functionality in the range from 1.7 to 2.5, preferably 1.8 to 2.2 more preferably 2, for the mixture.

It is particularly preferable for A) to utilize polyisocyanate prepolymers of the aforementioned kind which are based on hexamethylene diisocyanate, isophorone diisocyanate or the isomeric bis(4,4′-isocyanatocyclohexyl)methanes, and also mixtures of the aforementioned diisocyanates.

The isocyanate-functional prepolymers A) are prepared by reacting the low molecular weight polyisocyanates with the polyols at an NCO/OH ratio of preferably 2:1 to 20:1. The reaction temperature is generally in the range from 20 to 160° C. and preferably in the range from 60 to 100° C. A particularly preferred embodiment comprises subsequently removing the fraction of unconverted polyisocyanates by means of suitable methods. Thin-film distillation is customarily used for this purpose because it yields products having low residual monomer contents of less than 5% by weight, preferably less than 0.5% by weight and most preferably less than 0.1% by weight.

Suitable nonionically hydrophilicizing compounds of component B) are monofunctional polyoxyalkylene ethers which contain at least one hydroxyl group. Examples are the monohydroxyl-functional polyalkylene oxide polyether alcohols containing on average 5 to 70 and preferably 7 to 55 ethylene oxide units per molecule and obtainable in a conventional manner by alkoxylation of suitable starter molecules (for example in Ullmanns Encyclopädie der technischen Chemie, 4th edition, volume 19, Verlag Chemie, Weinheim pages 31-38). These are either pure polyethylene oxide ethers or mixed polyalkylene oxide ethers, containing at least 30 mol % of ethylene oxide units, based on all alkylene oxide units present.

Particularly preferred nonionic compounds are monofunctional mixed polyalkylene oxide polyethers having 30 to 100 mol % of ethylene oxide units and 0 to 70 mol % of propylene oxide units based on the total amount of oxyalkylene units.

Useful starter molecules for such building blocks include saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or oleyl alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methylcyclohexylamine, N-ethylcyclohexylamine or dicyclohexylamine and also heterocyclic secondary amines such as morpholine, pyrrolidine, piperidine or 1H pyrazole. Preferred starter molecules are saturated monoalcohols of the aforementioned kind. Particular preference is given to using diethylene glycol monobutyl ether or n-butanol as starter molecules.

Useful alkylene oxides for the alkoxylation reaction are in particular ethylene oxide and propylene oxide, which can be used in any desired order or else in admixture in the alkoxylation reaction.

Suitable building blocks of component C) are monohydric alcohol components consisting of at least one monohydric alcohol of the number average molecular weight range 32 to 5000 g/mol, which is other than the alcohols of component B). Examples are methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, fatty alcohols, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or oleyl alcohol, araliphatic alcohols such as benzyl alcohol, anisyl alcohol or cinnamyl alcohol.

Monofunctional polymers are also usable, examples being polyoxyalkylene ethers which contain a hydroxyl group, and less than 30 mol % of ethylene oxide. Preference is given to monofunctional polypropylene oxide polyethers with no ethylene oxide building blocks whatsoever.

Suitable building blocks of component D) are isocyanate-reactive components of the number average molecular weight range 32 to 10 000 g/mol which are polyfunctional for the purposes of the NCO addition reaction. Examples of low molecular weight polyols in particular, preferably with up to 20 carbon atoms, are ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A, (2,2-bis(4-hydroxy-cyclohexyl)propane), trimethylolpropane, glycerol, pentaerythritol and also any desired mixture thereof with each or one another. It is also possible to use polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols having a number average molecular weight of up to 10 000 g/mol. It is also possible to use particularly di- or polyamines such as 1,2-ethylene diamine, 1,2- and 1,3-diaminopropane, 1,4-diaminobutane, 1,6-diaminohexane, isophoronediamine, isomer mixtures of 2,2,4- and 2,4,4-trimethylhexamethylenediamine, 2-methylpentamethylenediamine, diethylenetriamine, triaminononane, 1,3- and 1,4-xylylenediamine, α,α,α′,α′-tetramethyl-1,3- and -1,4-xylylene-diamine and 4,4-diaminodicyclohexylmethane and/or dimethylethylenediamine. It is likewise possible to use hydrazine and also hydrazides such as adipodihydrazide. Preference is given to isophoronediamine, 1,2-ethylenediamine, 1,4-diaminobutane and diethylenetriamine. The component D) can further utilize compounds which as well as a primary amino group also have secondary amino groups or which as well as an amino group (primary or secondary) also have OH groups. Examples thereof are primary/secondary amines, such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine. Mixtures of the components mentioned are also usable as building block D).

One preferred version does not utilize component D), another preferred version utilizes at least one polyoxyalkylene ether as component D). A very particularly preferred version utilizes as component D) at least one polyoxyalkylene ether which contains at least two isocyanate-reactive groups such as hydroxyl groups and additionally at least 30 mol % of ethylene oxide units, based on all alkylene oxide units present. Particular preference for use as D) is given to difunctional polyalkylene oxide polyethers which include 30 to 100 mol % of ethylene oxide units and 0 to 70 mol % of propylene oxide units, and it is even more preferable for 70 to 100 mol % of ethylene oxide units and 0 to 30 mol % of propylene oxide units to be present. It is most preferable for ethylene oxide only to be present in D) as alkylene oxide units. Such polyoxyalkylene ethers are obtainable in a conventional manner by alkoxylation of suitable, at least difunctional starter molecules.

One preferred version of preparing the polyurethanes of the present invention comprises first preparing the isocyanate-functional prepolymer A) by reacting a diisocyanate of the aforementioned kind with a deficiency of a hydrophobic diol such as, for example, polypropylene glycol having a number average molecular weight of 2000 g/mol for example. The molar ratio between isocyanate groups and isocyanate-reactive groups in this reaction is preferably in the range from 2:1 to 20:1 and more preferably in the range from 5:1 to 15:1. After reaction of the isocyanate-reactive groups, a preferred version comprises removing at least a large portion of the remaining diisocyanate by distillation, for example by a thin-film evaporator and heating in vacuo. The mixture obtained in the process is subsequently reacted with component B) and optionally component C) and/or optionally with component D). Preference for use as component B) is then given to a monohydric polyether alcohol of the number average molecular weight range 350 to 3000 g/mol, more preferably 700 to 2300 g/mol, which preferably has an ethylene oxide unit content of 70% to 100% by weight, based on the total content of oxyalkylene units.

The molar ratio between isocyanate groups and isocyanate-reactive groups in the reaction of A) with B) and optionally C) and/or D) is preferably in the range from 0.5:1 to 2:1, more preferably in the range from 0.7:1 to 1.2:1 and most preferably equal to 1:1. Preferred temperature range for the reaction is 20 to 180° C. and more preferably 40 to 130° C. The reaction is preferably carried on until no isocyanate groups whatsoever are detectable by IR spectroscopy. One particularly preferred version utilizes neither C) nor D), another particularly preferred version utilizes D) only.

The use of catalysts known to a person skilled in the art is possible both in the preparation of prepolymers A) and in the preparation of the polyurethanes of the present invention. Tertiary amines, tin, zinc or bismuth compounds such as triethylamine, 1,4-diazabicyclo-[2,2,21-octane, tin dioctoate, dibutyltin dilaurate and zinc dioctoate can be added for example. Stabilizers such as benzoyl chloride, isophthaloyl chloride, dibutyl phosphate, 3-chloropropionic acid, antioxidants or methyl tosylate may be added during and/or after the preparation, if desired.

The polyurethanes of the present invention are preferably prepared using the components A) to D) in the following quantitative ranges:

10% to 80% by weight and more preferably 20% to 50% by weight for component A),

20% to 90% by weight and more preferably 30% to 50% by weight for component B),

0% to 15% by weight and more preferably 0% to 5% by weight for component C), and

0% to 60% by weight and more preferably 10% to 30% by weight for component D).

In addition to the components A), B), C) and D) mentioned, still further isocyanate building blocks and isocyanate-reactive building blocks which do not come within A), B), C) or D) may be incorporated in the polyurethanes of the present invention, but preferably at less than 20% by weight, and most preferably no building blocks other than A), B), C) and D) are present.

The present invention further provides for the use of the polyurethanes of the present invention as additive, auxiliary, added substance, emulsifier, compatibilizer, wetter, dispersant, stabilizer, modifier, release agent, thickener and/or adhesion promoter.

Application examples are the use in coatings, varnishes, paints, adhesives, laminating materials, sealants, printing inks, liquid inks, colorants, dyes, stains, mordants, bates, dressings, pickles, anticorrosive and antirust agents, impregnating agents and graphic materials, for producing wound contact materials and incontinence products, for producing pharmaceutical formulations, as lubricating, gliding, release or cooling agents, in motor fuels, as an oil, in or as thinning, cleaning and/or pretreatment agents, in food products of any kind.

Preference is given to the use of the polyurethanes of the present invention as foam stabilizers for polymers, preferably those based on polyurethane. The use according to the present invention preferably engenders a hydrophilicization of the foams as well as stabilization. The aforementioned foams preferably comprise foams obtained from aqueous polyurethane dispersions by physical drying.

The polyurethanes of the present invention can be used in the aforementioned fields of use together with solvents such as, for example, water, thickeners or thixotroping agents, stabilizers, free-radical scavengers, binders, foaming assistants, antioxidants, photoprotectants, emulsifiers, plasticizers, pigments, fillers and/or flow control agents.

Further added substances are crosslinkers, thickeners or thixotroping agents, other aqueous binders, antioxidants, photoprotectants, emulsifiers, plasticizers, pigments, fillers and/or flow control agents.

Such thickeners can be derivatives of dextrin, of starch or of cellulose, examples being cellulose ethers or hydroxyethylcellulose, organic wholly synthetic thickeners based on polyacrylic acids, polyvinylpyrrolidones, poly(meth)acrylic compounds or polyurethanes (associative thickeners) and also inorganic thickeners, such as bentonites or silicas.

Useful such crosslinkers include for example unblocked polyisocyanates, amide- and amine-formaldehyde resins, phenolic resins, aldehydic and ketonic resins, examples being phenol-formaldehyde resins, resols, furan resins, urea resins, carbamic ester resins, triazine resins, melamine resins, benzoguanamine resins, cyanamide resins or aniline resins.

Other aqueous binders can be constructed for example of polyester, polyacrylate, polyepoxy or other polyurethane polymers. Similarly, the combination with radiation-curable binders as described for example in EP-A-0 753 531 is also possible. It is further possible to employ other anionic or nonionic dispersions, such as polyvinyl acetate, polyethylene, polystyrene, polybutadiene, polyvinyl chloride, polyacrylate and copolymer dispersions.

The polymer foams which are advantageously stabilizable by the polyurethanes of the present invention can be based on polyvinyl chlorides, polyacrylates, polycarbonimides, polymethacrylimides, polyamides, phenolic and urea resins, polysiloxanes, polyaminoamines, poly(hydroxy carboxylic acids, polycarbonates, polyesters, polyester polyamides, polyester polyacrylates, polyester polycarbonates, polyoxyalkylene ethers, polyether polyacrylates, polyether polycarbonates, polyether polyamides, polyethylene polyimines, polyureas, polyurethanes, polyurethane polyacrylates, polyurethane polyesters, polyurethane polyethers, polyurethane polyureas and polyurethane polycarbonates and also any desired mixtures thereof. Preference is given to using polyureas, polyurethanes, polyurethane polyacrylates, polyurethane polyesters, polyurethane polyethers, polyurethane polyureas and polyurethane polycarbonates and also any desired mixtures thereof.

The polyurethanes of the present invention display advantageous effects in the aforementioned applications even when used in low amounts. The amounts in which the polyurethanes of the present invention are used preferably range from 0.1 to 15 parts by weight, more preferably from 0.5 to 10 parts by weight and most preferably from 1 to 6 parts by weight based on the solids content of the composition.

The polyurethanes of the present invention can be used in the aforementioned applications with flexibility and can be used therein dissolved or dispersed in a solvent such as water, where appropriate.

### EXAMPLES

Unless indicated otherwise, all percentages are by weight. The contents reported for foam additives are based on aqueous solutions.

Solids contents were determined in accordance with DIN-EN ISO 3251.

NCO contents, unless expressly mentioned otherwise, were determined volumetrically in accordance with DIN-EN ISO 11909.

The determination of the average particle size (the number average is reported) of polyurethane dispersion 1 was carried out using laser correlation spectroscopy (instrument: Malvern Zetasizer 1000, Malver Inst. Limited).

The polypropylene glycol polyethers used were prepared by DMC catalysis (without base), unless otherwise mentioned.

The molar masses reported are weight average molar masses, unless otherwise mentioned. They were determined by GPC analysis in tetrahydrofuran at a flow rate of 0.6 ml/min Polystyrene standards were used for calibration.

Substances and Abbreviations Used:
Diaminosulfonate: NH₂—CH₂CH₂—NH—CH₂CH₂—SO₃Na (45% in water)
Desmophen® C2200: polycarbonate polyol, OH number 56 mg KOH/g, number average molecular weight 2000 g/mol (Bayer MaterialScience AG, Leverkusen, Germany)
PolyTHF® 2000: polytetramethylene glycol polyol, OH number 56 mg KOH/g, number average molecular weight 2000 g/mol (BASF AG, Ludwigshafen, Germany)
PolyTHF® 1000: polytetramethylene glycol polyol, OH number 112 mg KOH/g, number average molecular weight 1000 g/mol (BASF AG, Ludwigshafen, Germany)
Polyether LB 25: monofunctional polyether based on ethylene oxide/propylene oxide, number average molecular weight 2250 g/mol, OH number 25 mg KOH/g (Bayer MaterialScience AG, Leverkusen, Germany)
HDI: hexamethylene 1,6-diisocyanate

### Example 1

### Preparation of Polyurethane Dispersion 1

1077.2 g of PolyTHF® 2000, 409.7 g of PolyTHF® 1000, 830.9 g of Desmophen® C2200 and 48.3 g of LB 25 polyether were heated to 70° C. in a standard stirred apparatus. Then, a mixture of 258.7 g of hexamethylene diisocyanate and 341.9 g of isophorone diisocyanate was added at 70° C. in the course of 5 min and the resulting mixture was stirred at 120° C. until the theoretical NCO value was reached or the actual NCO value had dropped slightly below the theoretical NCO value. The final prepolymer was dissolved with 4840 g of acetone and, in the process, cooled down to 50° C. and subsequently admixed with a solution of 27.4 g of ethylenediamine, 127.1 g of isophoronediamine, 67.3 g of diaminosulphonate and 1200 g of water metered in over 10 min The mixture was subsequently stirred for 10 min Then, a dispersion was formed by addition of 654 g of water. This was followed by removal of the solvent by distillation under reduced pressure.

The polyurethane dispersion obtained had the following properties:

Solids content: 59.0%

Particle size (LCS): 487 nm

pH (23° C.): 7.1

### Example 2

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr; there was 1 g of chloropropionic acid in the initially charged flask. The NCO prepolymer obtained had an NCO content of 3.23% and a viscosity of 1650 mPas (25° C.).

A 2 l four-neck flask was initially charged with 225 g of Polyether LB 25 polyether and 100 g of a difunctional polyethylene glycol polyether having a number average molecular weight of 2000 g/mol with stirring. 260 g of the abovementioned NCO prepolymer were added at 80° C. during 2.5 hours, followed by stirring at 80° C. for 4 hours, until NCO groups were no longer detectable by IR spectroscopy. The surfactant obtained was a solid having a weight average molar mass of 21 346 g/mol.

### Example 3

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 l four-neck flask was initially charged with 600 g of a monofunctional polyethylene glycol polyether (MeOPEG) having a number average molecular weight of 2000 g/mol with stirring. 202 g of the abovementioned NCO prepolymer were added at 70° C. during 0.5 hours, followed by stirring at 80° C. for 4 hours, until NCO groups were no longer detectable by IR spectroscopy. The surfactant obtained was a solid having a weight average molar mass of 7232 g/mol.

### Example 4

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 l four-neck flask was initially charged with 750 g of a monofunctional polyethylene glycol polyether (MeOPEG) having a number average molecular weight of 5000 g/mol with stirring. 101 g of the abovementioned NCO prepolymer were added at 70° C. during 0.5 hours, followed by stirring at 80° C. for 4 hours, until NCO groups were no longer detectable by IR spectroscopy. The surfactant obtained was a solid having a weight average molar mass of 13 849 g/mol.

### Example 5

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 l four-neck flask was initially charged with 675 g of Polyether LB 25 polyether with stirring. 202 g of the abovementioned NCO prepolymer were added at 70° C. during 0.5 hours, followed by stirring at 90° C. for 5 hours, until NCO groups were no longer detectable by IR spectroscopy. The surfactant obtained had a viscosity of 5750 mPas (25° C.) and a weight average molar mass of 9511 g/mol.

### Example 6

2000 g of HDI, 1.3 g of benzoyl chloride and 1.3 g of methyl para-toluenesulphonate were initially charged to a 4 litre four-neck flask with stirring. 1000 g of a difunctional polypropylene glycol polyether having a number average molecular weight of 1000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 6.24% and a viscosity of 1650 mPas (25° C.).

A 2 l four-neck flask was initially charged with 281 g of Polyether LB 25 polyether and 125 g of a difunctional polyethylene glycol polyether having a number average molecular weight of 2000 g/mol with stirring. 167.5 g of the abovementioned NCO prepolymer were added at 80° C. during 2.5 hours, followed by stirring at 80 to 100° C. for 5 hours, until NCO groups were no longer detectable by IR spectroscopy. The surfactant obtained was a solid.

### Example 7

A 2 l four-neck flask was initially charged with 337 g of Polyether LB 25 polyether and 150 g of a difunctional polyethylene glycol polyether having a number average molecular weight of 2000 g/mol with stirring. 98.5 g Desmodur E 305 (Desmodur E 305 is a substantially linear NCO prepolymer based on hexamethylene diisocyanate, NCO content about 12.8%) are added at 80° C. during 2.5 hours, followed by stirring at 90 to 110° C. for 5 hours, until NCO groups were no longer detectable by IR spectroscopy. The surfactant obtained was a solid.

### Example 8

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2l four-neck flask was initially charged with 100 g of a difunctional polyethylene glycol polyether having a number average molecular weight of 2000 g/mol with stirring. 258 g of the abovementioned NCO prepolymer were added at 80° C. during 2.5 hours, followed by stirring at 100° C. for 3 hours. Then, 225 g of Polyether LB 25 polyether were added, followed by stirring at 115° C. for 2.5 hours, until NCO groups were no longer detectable by IR spectroscopy. The surfactant obtained was a very viscous liquid.

### Example 9

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2 l four-neck flask was initially charged with 112.5 g of Polyether LB 25 polyether and 150 g of a difunctional polyethylene glycol polyether having a number average molecular weight of 2000 g/mol with stirring. 257 g of the abovementioned NCO prepolymer were added at 80° C. during 0.5 hours, followed by stirring at 100-115° C. for 4 hours, until NCO groups were no longer detectable by IR spectroscopy. The surfactant obtained was a solid.

### Example 10

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2 l four-neck flask was initially charged with 287 g of Polyether LB 25 polyether and 42.5 g of a difunctional polyethylene glycol polyether having a number average molecular weight of 2000 g/mol with stirring. 220 g of the abovementioned NCO prepolymer were added at 80° C. during 0.5 hours, followed by stirring at 100-120° C. for 5 hours, until NCO groups were no longer detectable by IR spectroscopy. The surfactant obtained was a very high-viscosity liquid.

### Example 11

1300 g of HDI, 1.3 g of benzoyl chloride and 1.3 g of methyl para-toluenesulphonate were initially charged to a 4 litre four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.23% and a viscosity of 1650 mPas (25° C.).

A 2l four-neck flask was initially charged with 200 g of a monofunctional polyethylene glycol polyether (MeOPEG) having a number average molecular weight of 2000 g/mol and 100 g of a difunctional polyethylene glycol polyether having a number average molecular weight of 2000 g/mol with stirring. 257 g of the abovementioned NCO prepolymer were added at 80° C. during 0.5 hours, followed by stirring at 100-120° C. for 4 hours, until NCO groups were no longer detectable by IR spectroscopy. The surfactant obtained was a solid

### Example 12

1300 g of HDI and 0.3 g of dibutyl phosphate were initially charged to a 4 l four-neck flask with stirring. 1456 g of a difunctional polypropylene glycol polyether having a number average molecular weight of 2000 g/mol were added at 80° C. during 3 hours, followed by stirring at 80° C. for 1 hour. Excess HDI was subsequently removed by thin-film distillation at 130° C. and 0.1 Torr; there was 2 g of Ronotec 201 (tocopherol) in the initially charged flask. The NCO prepolymer obtained had an NCO content of 3.27% and a viscosity of 1680 mPas (25° C.).

A 2 l four-neck flask was initially charged with 225 g of Polyether LB 25 polyether and 100 g of a difunctional polyethylene glycol polyether having a number average molecular weight of 2000 g/mol with stirring. 260 g of the abovementioned NCO prepolymer were added at 70° C. during 2.5 hours, followed by stirring at 70° C. for 5 hours, until NCO groups were no longer detectable by IR spectroscopy. The surfactant obtained was a solid.

### Example 13

1300 g of HDI were initially charged to a 4 l four-neck flask with stirring. 1456 g of a difunctional polypropylene glycol polyethylene glycol polyether having a number average molecular weight of 2000 g/mol and an ethylene oxide units content of 24% by weight were added at 80° C. with stirring, followed by stirring at 80° C. for 1 hour. Excess HDI was subsequently removed by thin-film distillation at 130° C. and 0.1 Torr. The NCO prepolymer obtained had an NCO content of 1.99% and a viscosity of 1040 mPas (25° C.).

A 2 l four-neck flask was initially charged with 169 g of Polyether LB 25 polyether and 75.0 g of a difunctional polyethylene glycol polyether having a number average molecular weight of 2000 g/mol with stirring. 284 g of the abovementioned NCO prepolymer were added at 70° C. during 2.5 hours, followed by stirring at up to 110° C. for 5 hours, until NCO groups were no longer detectable by IR spectroscopy. The surfactant obtained was a solid.

### Example 14

1400 g of HDI and 0.2 g of isophthaloyl chloride were initially charged to a 4 l four-neck flask with stirring. 1400 g of a difunctional polypropylene glycol polyether having a number average molecular weight of 2000 g/mol (prepared by KOH-catalyzed polymerization) were added at 80° C. during 3 hours, followed by stirring at 80° C. for 1 hour. Excess HDI was subsequently removed by thin-film distillation at 130° C. and 0.1 Torr. The NCO prepolymer obtained had an NCO content of 3.6% and a viscosity of 1480 mPas (25° C.).

A 2 l four-neck flask was initially charged with 225 g of Polyether LB 25 polyether and 100 g of a difunctional polyethylene glycol polyether having a number average molecular weight of 2000 g/mol with stirring. 233 g of the abovementioned NCO prepolymer were added at 70° C. during 2.5 hours, followed by stirring at not more than 115° C. for 3 hours, until NCO groups were no longer detectable by IR spectroscopy. The surfactant obtained was a solid.

### Example 15

### Comparative

Preparation of a Surfactant on the Basis of a Polyisocyanurate A) Having an Average Isocyanate Functionality of About 3.5

An initial charge in a 2 l four-neck flask of 253 g of a polyisocyanurate based on hexamethylene diisocyanate (average NCO functionality about 3.5) was admixed, at 80° C. by stirring, with 988 g of a monofunctional polyethylene glycol polyether (MeOPEG) having a number average molecular weight of 760 g/mol during 0.5 hours. The mixture was then stirred at 80-90° C. for 6 hours until NCO groups were no longer detectable by IR spectroscopy. The surfactant obtained was a solid having a weight average molar mass of 4491 g/mol.

### Example 16

### Comparative

Preparation of a Surfactant (I) on the Basis of a Diisocyanate

42 g of HDI were initially charged to a 2 l four-neck flask with stirring. 1125 g of Polyether LB 25 polyether were added at 80° C. during 1 hour, followed by stirring at 80° C. for 12 hours. The surfactant obtained had a viscosity of 2970 mPas (25° C.) and a weight average molar mass of 6885 g/mol.

### Example 17

### Comparative

Preparation of a Surfactant on the Basis of a Polyisocyanate Prepolymer A) Having an Average Isocyanate Functionality of 4

An initial charge in a 2 l four-neck flask of 136 g of a polyether polyurethane prepolymer based on hexamethylene diisocyanate having 6.0% by weight of NCO (average NCO functionality about 4) was admixed, at 80° C. by stirring, with 450 g of Polyether LB 25 polyether during 0.5 hours. The mixture was then stirred at 90-100° C. for 4 hours until NCO groups were no longer detectable by IR spectroscopy. The surfactant was a liquid having a viscosity of about 11 000 mPas (23° C.).

### Example 18

### Comparative

A surfactant was prepared using the same raw materials as in Example 12, except that the prior preparation of the prepolymer from the diisocyanate with the polypropylene glycol polyether was omitted and the surfactant synthesis was performed in one reaction step only.

A 4 l four-neck flask was initially charged with 201.60 g of a difunctional polypropylene glycol polyether having a number average molecular weight of 200 g/mol, 202.5 g of Polyether LB 25 polyether and 90 g of a difunctional polyethylene glycol polyether having a number average molecular weight of 2000 g/mol, 0.04 g of dibutyl phosphate and also 0.28 g of Ronotec 201 (tocopherol) at 80° C. with stirring. 30.24 g of HDI were added and stirring was continued at 80° C. until isocyanate groups were no longer detectable by IR spectroscopy. The surfactant obtained was a solid.

### Examples S1-S5

### Inventive

As indicated in Table 1, 120 g, for each example, of polyurethane dispersion 1, prepared according to Example 1, were mixed with various (foam) additives and frothed by means of a commercially available hand stirrer (stirrer made of bent wire) to a 0.5 litre foam volume. Thereafter, the foams were drawn down on non-stick paper by means of a blade coater at a gap height of 6 mm and dried at 120° C. for 20 minutes.

Fresh white foams having good mechanical properties were obtained without exception. As is discernible from Table 1, using the specific (foam) additives 2, 5, 6, 10 and 12 resulted in foams being obtained which combined a high imbibition rate with regard to physiological saline and good free swell absorptive capacity with a fine, homogeneous pored structure.

By way of example, foam S5 was tested according to ISO 10993.5 and found to be non-cytotoxic.

TABLE 1

| | | Amount | | | |
|---|---|---|---|---|---|
| | | [g] | Imbibition | | |
| | Example | (content | rate¹⁾ | Free swell²⁾ | Porosity/ |
| Foam | # | [%]) | [s] | [g/100 cm²] | foam structure |
| S1 | 2 | 25.3 (15) | 48 | not | very fine |
| | | | | determined | |
| S2 | 5 | 12.6 (30) | 4 | 30 | very fine |
| S3 | 6 | 12.4 (30) | 15 | 56 | medium |
| S4 | 10 | 13.2 (28) | 28 | 46 | fine |
| S5 | 12 | 11.8 (25) | 44 | 47 | very fine |

¹⁾Time for complete penetration of one millilitre of test solution A prepared as in DIN EN 13726-1 Part 3.2; test on side facing the paper;
²⁾Free swell absorptive capacity was determined to DIN EN 13726-1 Part 3.2.

### Comparative Examples V1-V4

Production of Foams from Polyurethane Dispersion 1 and a Surfactant

For each example, 120 g of polyurethane dispersion 1 were mixed with various additives not according to the invention (Table 2) and frothed by means of a commercially available hand stirrer (stirrer made of bent wire) to a 0.5 litre foam volume. Thereafter, the foams were drawn down on non-stick paper by means of a blade coater at a gap height of 6 mm and dried at 120° C. for 20 minutes.

The resulting foams had particularly disadvantageous properties such as foam structure inhomogeneity, surface defects (cracks) or else pocketing (formation of two layers of foam which scarcely adhered to each other, if at all: the result is a void space in the form of a pocket).

TABLE 2

| | Example | Amount [g] | |
|---|---|---|---|
| Foam | # | (content [%]) | Porosity/foam structure |
| V1 | 15 | 12.5 (30) | pocketing, foam structure |
| | | | inhomogeneity |
| V2 | 16 | 12.6 (30) | pocketing, pronounced filming, |
| | | | foam structure inhomogeneity |
| V3 | 17 | 12.4 (30) | foam structure inhomogeneity, |
| | | | surficial cracking |
| V4 | 18 | 9.8 (30) | pocketing, foam structure |
| | | | inhomogeneity |

The comparative examples in Table 2 show that the use of high-functionality polyisocyanate components as raw material (V1 and V2) or the direct use of a low molecular weight diisocyanate instead of a diisocyanate prepolymer (V3 and V4) does not result in a product that is suitable.

### Comparative Examples V5-V6

Production of Foams from Polyurethane Dispersion 1 and a Surfactant

As indicated in Table 3, 120 g, for each example, of polyurethane dispersion 1, prepared according to Example 1, were mixed with various (foam) additives and frothed by means of a commercially available hand stirrer (stirrer made of bent wire) to a 0.5 litre foam volume. Thereafter, the foams were drawn down on non-stick paper by means of a blade coater at a gap height of 6 mm and dried at 120° C. for 20 minutes.

As is discernible from Table 3, the foams V5 and V6 have an additive-caused, strongly cytotoxic effect when tested to ISO 10993.5: cell viabilities were below 3% with these foams.

TABLE 3

| | (Foam) additives | | | | Porosity/ | |
|---|---|---|---|---|---|---|
| | | Amount | | Amount | foam | |
| Foam | Type¹⁾ | [g] | Type¹⁾ | [g] | structure | Cytotoxicity²⁾ |
| V5 | A | 4.34 | B | 5.76 | very fine | strongly |
| | | | | | | cytotoxic |
| V6 | A | 0.24 | C | 1.47 | fine, but | strongly |
| | | | | | graining & | cytotoxic |
| | | | | | volume | |
| | | | | | shrinkage | |

¹⁾A: ammonium stearate (ca. 30%, Stokal ® STA, Bozzetto GmbH, Krefeld, DE); B: sulphosuccinamate (ca. 34%, Stokal ® SR, Bozzetto GmbH, Krefeld, DE); C: C12-C16 fatty alcohol polyglycoside (ca. 51%, PlantaCare ® 1200 UP, Cognis Deutschland GmbH & Co. KG, Dusseldorf, DE);
²⁾Tested to ISO 10993.5

1.-10. (canceled)

11. A polyurethane having a free isocyanate group content of less than or equal to 1.0% by weight and a content of ethylene oxide units of from 10% to 95% by weight incorporated via monofunctional alcohols B) and arranged within polyether chains, wherein the polyurethane is prepared by reaction of:
A) polyisocyanate prepolymers having an average NCO functionality of from 1.7 to 2.5; with
B) 10 to 100 equivalent %, based on the isocyanate groups of A), of a monohydric alcohol component comprising at least one monohydric polyether alcohol having a number average molecular weight in the range from 150 to 5000 g/mol and an oxyethylene units content of 30 to 100% by weight, based on the total content of oxyalkylene units in the monohydric polyether alcohol,
C) 0 to 20 equivalent %, based on the isocyanate groups of A), of a monohydric alcohol component comprising monohydric alcohols having a number average molecular weight of from 32 to 5000 g/mol which are in addition to the compounds of component B),
D) 0 to 80 equivalent %, based on the isocyanate groups of A), of constructional components having a number average molecular weight of from 32 to 10 000 g/mol which are at least difunctional with urethane formation and with or without urea formation, wherein any excess NCO groups have been reacted away, by simultaneous or subsequent secondary reactions, down to a residual content of less than or equal to 1.0% by weight.

12. The polyurethane according to claim 11, wherein the content of ethylene oxide units is from 45 to 55% by weight.

13. The polyurethane according to claim 11, wherein the polyisocyanate prepolymers have exclusively aliphatically or cycloaliphatically attached isocyanate groups or mixtures thereof and an average NCO functionality of from 1.8 to 2.2 for the mixture.

14. The polyurethane according to claim 11, wherein the polyisocyanate prepolymers are produced with polyether polyols having number average molecular weights Mn of from 300 to 8000 g/mol.

15. The polyurethane according to claim 14, wherein the polyether polyols have a polydispersity of from 1.0 to 1.5; an OH functionality of greater than 1.9; and an unsaturated end group content of less than or equal to 0.02 milliequivalents per gram of polyol as determined by ASTM D2849-69.

16. The polyurethane according to claim 11, wherein the monohydric alcohol component comprises monohydroxyl-functional polyalkylene oxide polyether alcohols which on average comprise 5 to 70 ethylene oxide units per molecule and 30 to 100 mol % of ethylene oxide units and 0 to 70 mol % of propylene oxide units based on the total amount of oxyalkylene units.

17. The polyurethane according to claim 11, wherein the molar ratio between isocyanate groups and isocyanate-reactive groups in the reaction of A) with B) and optionally C) and/or D) is from 0.5:1 to 2:1.

18. An additive, auxiliary, added substance, emulsifier, compatibilizer, wetter, dispersant, stabilizer, modifier, release agent, thickener and/or adhesion promoter comprising the polyurethane according to claim 11.

19. A stabilizer for foam structures comprising the polyurethane according to claim 11.

20. Articles produced, additized, enhanced or treated using the polyurethane according to claim 11.
